(19) United States
(12) Patent Application Publication
(10) Pub. No.: US 2026/0184137 A1
(43) Pub. Date: Jul. 2, 2026

(54) COOLING APPARATUS FOR VEHICLE AND VEHICLE

(71) Applicant: Isuzu Motors Limited, Yokohama-shi (JP)

(72) Inventors: Hiroaki SAKATA, Fujisawa-shi (JP); Mizuki OKAMOTO, Fujisawa-shi (JP)

(73) Assignee: Isuzu Motors Limited, Yokohama-shi (JP)

(21) Appl. No.: 19/377,406

(22) Filed: Nov. 3, 2025

(30) Foreign Application Priority Data
Dec. 26, 2024 (JP) 2024-230799

(51) Int. Cl. B60H 1/32; B60H 1/00

(52) U.S. Cl. CPC B60H 1/3227; B60H 1/00457

(57) ABSTRACT

A cooling apparatus for a vehicle, includes a condenser at a back of an air intake port, a radiator provided at a back of the condenser, and a fan configured to allow the air from the air intake port to blow to the condenser and the radiator. A space between bottom parts of a rear surface section of the condenser and a front surface section of the radiator is greater than a space between top parts of the rear surface section of the condenser and the front surface section of the radiator, or a space between end parts of the rear surface section and the front surface section at one of a right side and a left side is greater than a space between end parts of the rear surface section and the front surface section at a remaining side of the right side and the left side.

### CROSS REFERENCE TO RELATED APPLICATIONS

This application is based upon and claims the benefit of priority from prior Japanese Patent Application No. 2024-230799, filed Dec. 26, 2024, the entire contents of which are incorporated herein by reference.

### FIELD

The present invention relates to a cooling apparatus for a vehicle and a vehicle including the cooling apparatus.

### BACKGROUND

For example, Jpn. Pat. Appln. KOKAI Publication No. 2017-106411 discloses an example of a cooling apparatus in which a condenser and a radiator are disposed side by side in such a manner that air that has passed through an air intake port such as a front grille that opens to the front surface of the vehicle blows to the condenser and the radiator in this order. In Jpn. Pat. Appln. KOKAI Publication No. 2017-106411, the condenser and the radiator are placed in contact with and in parallel with each other in a front-back direction, and stand upright on a horizontal surface, for example.

Jpn. Pat. Appln. KOKAI Publication No. 2002-337539 discloses, for example, a condenser whose top side is further inclined to the front than its bottom side. A fan is provided at a rear surface of the condenser. A radiator is provided further back of the condenser and the fan so as to be distanced therefrom. Air that has been introduced from an air intake port is blown to the radiator from outside the condenser and the fan.

### SUMMARY

According to an aspect of the invention, a cooling apparatus for a vehicle, includes: a condenser provided at a back of an air intake port that opens to a front surface of the vehicle, the condenser including a first front surface section and a first rear surface section, the first front surface section receiving air that has passed through the air intake port; a radiator provided at a back of the condenser, the radiator including a second front surface section and a second rear surface section, the second front surface section facing the first rear surface section; and a fan provided on a side of the second rear surface section of the radiator and configured to allow the air from the air intake port to blow to the condenser and the radiator. A space between bottom parts of the first rear surface section of the condenser and the second front surface section of the radiator is greater than a space between top parts of the first rear surface section of the condenser and the second front surface section of the radiator, or a space between end parts of the first rear surface section of the condenser and the second front surface section of the radiator at one of a right side and a left side is greater than a space between end parts of the first rear surface section of the condenser and the second front surface section at a remaining side of the right side and the left side.

### BRIEF DESCRIPTION OF THE DRAWINGS

FIG. 1 is a schematic diagram showing an arrangement of a cooling apparatus at a front section of a vehicle and a heat source at its back, according to a first embodiment.

FIG. 2 is a schematic perspective view showing an example of a condenser and a radiator of the cooling apparatus shown in FIG. 1, as well as a left bracket for determining a positional relationship therebetween.

FIG. 3 is a schematic perspective view showing an example of a condenser and a radiator of the cooling apparatus shown in FIG. 1, as well as a right bracket for determining a positional relationship therebetween.

FIG. 4 is a schematic view showing a plate of the left bracket in FIG. 2, provided along a plane that is defined by top-bottom and front-back directions.

FIG. 5 is a schematic view showing a modification of the plate shown in FIG. 4.

FIG. 6 is a schematic diagram showing an arrangement of a cooling apparatus at a front section of a vehicle and a heat source at its back, according to a second embodiment.

### DETAILED DESCRIPTION

Hereinafter, a vehicle 10 including a cooling apparatus 12 according to an embodiment of the present invention will be described with reference to the accompanying drawings.

### First Embodiment

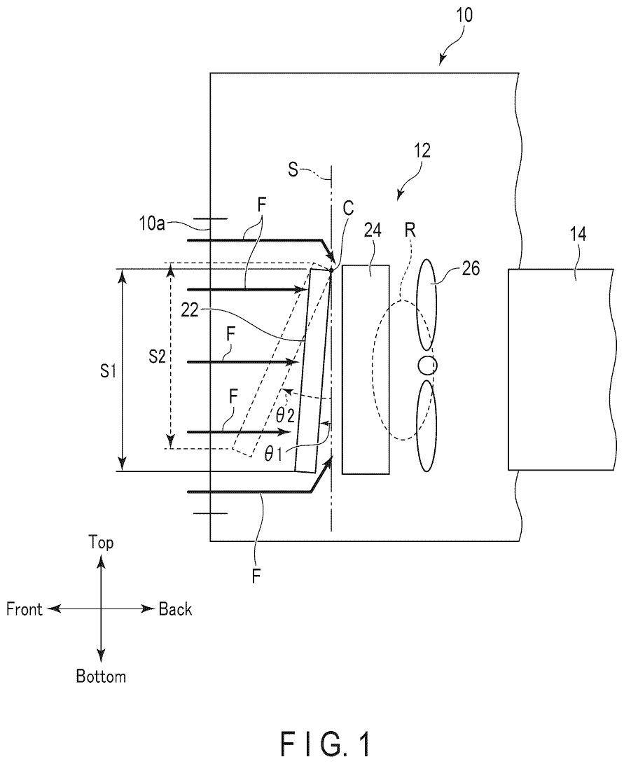

A vehicle 10 including a cooling apparatus 12 according to a first embodiment will be described with reference to FIGS. 1 to 5.

FIG. 1 is a schematic diagram showing a part of a front section of the vehicle 10 according to the first embodiment. The front, back, top, and bottom of the vehicle 10 are assumed as shown in FIG. 1.

As shown in FIG. 1, the vehicle 10 includes an intake port 10a for air F configured to be open to a front surface of the vehicle 10. Examples of the intake port 10a for the air F include a grille (front grille) provided in, for example, a body of the vehicle 10, and configured to allow the air F to enter a body during traveling, etc., of the vehicle 10. The intake port 10a for allowing the air F to enter the body is not limited to a grille, and may be provided at other positions, for example, at a bottom side of the front surface of the vehicle 10.

The vehicle 10 includes a cooling apparatus 12 and a heat source 14 provided at, for example, the back of the cooling apparatus 12.

The cooling apparatus 12 is provided further back of the vehicle 10 than the intake port 10a for the air F. The cooling apparatus 12 includes a condenser (first heat exchanger) 22, a radiator (second heat exchanger) 24, and a fan 26. It is preferable that the condenser 22, the radiator 24, and the fan 26 be provided at the center of the vehicle 10 or in the vicinity thereof in its width direction. The condenser 22 is provided at the back of the grille so as to face the grille, which acts as the intake port 10a. The radiator 24 is provided at the back of the condenser 22. The fan 26 is provided on a rear surface side of the radiator 24.

The condenser 22 is used as, for example, a heat exchanger for air conditioning in a carburetor (not illustrated). The condenser 22 is adapted, for example, to perform heat exchange between a gaseous refrigerant and air F allowed to enter from the intake port 10a, thereby cooling the gaseous refrigerant. In outer appearance, the condenser 22 is formed in an approximately parallelepiped shape. The condenser 22 includes a first front surface section 22a and a first rear surface section 22b, which form a pair of largest-area surfaces of the approximately parallelepiped shape of the condenser 22. The front surface section 22a of the condenser 22 faces the intake port (grille) 10a, so as to allow air F that has passed through the intake port 10a to be blown to the front surface section 22a. In the present embodiment, it is preferable that a fan not be provided at a rear surface of the condenser 22, namely, between the rear surface section 22b of the condenser 22 and a front surface section 24a of the radiator 24.

For convenience of explanation, it is assumed that the front surface section 22a and the rear surface section 22b of the condenser 22 are flat surfaces that are parallel to each other. It is also assumed that the front surface section 22a and the rear surface section 22b of the condenser 22 have the same size. The front surface section 22a and the rear surface section 22b of the condenser 22 are inclined toward a front surface section 24a and a rear surface section 24b, to be described below, of the radiator 24. Depending on the degree of inclination of the radiator 24, the front surface section 22a and the rear surface section 22b of the condenser 22 may be parallel to a plane S that defines the top, bottom, left, and right of the vehicle 10. In the present embodiment, it is assumed that the front surface section 22a and the rear surface section 22b of the condenser 22 are inclined to a plane S that defines the top, bottom, left, and right of the vehicle 10. In the present embodiment, a top part of the condenser 22 is provided further back than a bottom part of the condenser 22.

The condenser 22 pivots around a central axis C, which extends in a right-left direction, and is fastened at a desired angle. The central axis C may be provided at an upper end (upper edge) of the rear surface section 22b of the condenser 22, or may be provided further above the upper end of the rear surface section 22b of the condenser 22. An example will be described herein in which the central axis C is at the upper end of the rear surface section 22b of the condenser 22.

It is assumed that the rear surface section 22b of the condenser 22 is deviated, by an angle θ around the central axis C, from the above-described plane S that defines the top, bottom, left, and right of the vehicle 10, in which the central axis C is included. It is assumed that a position of the condenser 22 denoted by a solid line and a position of the condenser 22 denoted by a dashed line are deviated by the angle θ around the central axis C. It is assumed herein that the angle θ in the front direction from the plane S is positive. Assuming that the front surface section 24a of the radiator 24 is parallel to the plane S, it is preferable that θ>0° be satisfied. In the case of using brackets 32 and 34, to be described below, assuming that the front surface section 24a of the radiator 24 is parallel to the plane S, θ=0° may be satisfied if the amount of heat generation of the heat source 14 is expected to be suppressed to a relatively low degree. Accordingly, θ≥0° may be satisfied.

Note that FIG. 1 shows an example in which the angle θ of the condenser 22 denoted by the solid line satisfies θ1>0°, and the angle θ of the condenser 22 denoted by the dashed line satisfies θ2>θ1>0°. An upper limit value of the angle θ can be suitably set according to an area over which the front surface section 22a of the condenser 22 receives the air F, a relationship with the amount of heat scheduled to be generated by the heat source 14, and the like, and may be set to, for example, greater than 30° and equal to or less than 45°.

The radiator 24 is used as, for example, a heat exchanger designed to cool a coolant that circulates through the heat source 14, which is, for example, an engine, a motor, a battery, an electric control unit (ECU), etc. The radiator 24 is adapted, for example, to perform, for example, heat exchange between the coolant and the air F allowed to enter from the intake port 10a to cool the coolant. The radiator 24 may be either a downflow radiator configured to flow a coolant from top to bottom, or may be a crossflow radiator configured to flow a coolant in a horizontal direction.

In outer appearance, the radiator 24 is formed in an approximately parallelepiped shape, similarly to the condenser 22. The radiator 24 includes a second front surface section 24a and a second rear surface section 24b, which form a pair of largest-area surfaces of the approximately parallelepiped shape of the radiator 24. The front surface section 24a of the radiator 24 faces the rear surface section 22b of the condenser 22, so as to allow the air F that has entered from the intake port 10a and has passed through the condenser 22 and the air F that has circulated through the outside of the condenser 22 to be blown to the front surface section 24a.

The front surface section 24a, which is one of the pair of largest-area surfaces of the approximately parallelepiped shape of the radiator 24, faces the rear surface section 22b of the condenser 22, and the other largest-area surface faces the fan 26. For convenience of explanation, it is assumed that the front surface section 24a and the rear surface section 24b of the radiator 24 are planes that are parallel to each other. It is also assumed that the front surface section 24a and the rear surface section 24b of the radiator 24 have the same size.

It is preferable that the condenser 22 and the radiator 24 be formed in, for example, an approximately equal size. It is thus preferable that the cooling apparatus 12 as viewed from the front of the vehicle 10 be configured in such a manner that the front surface section 22a of the condenser 22 is visible but the front surface section 24a of the radiator 24 is invisible or hardly visible.

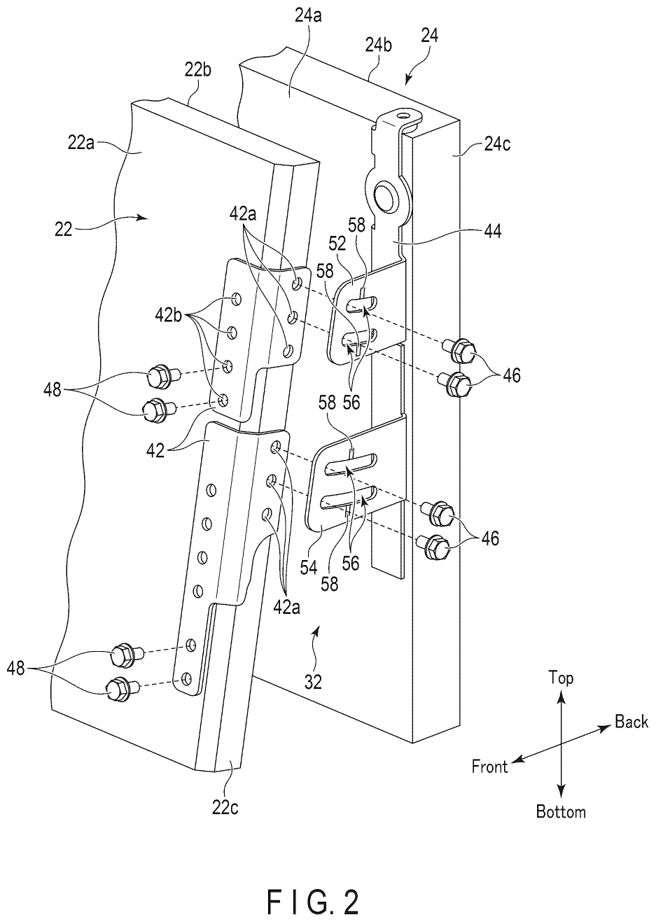

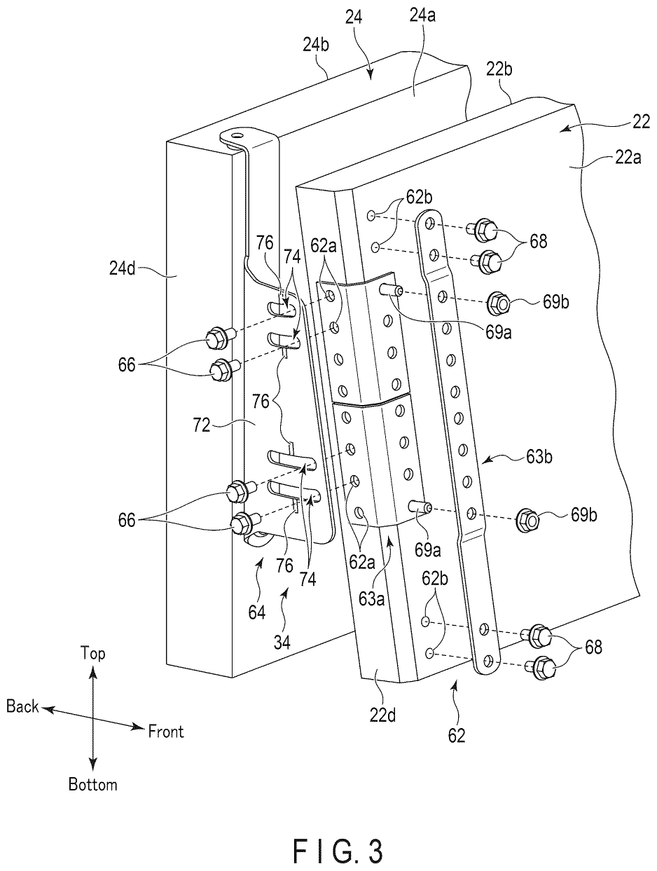

As shown in FIGS. 2 and 3, the condenser 22 includes a left lateral section (first left lateral section) 22c between the front surface section 22a and the rear surface section 22b, and a right lateral section (first right lateral section) 22d between the front surface section 22a and the rear surface section 22b. Also, the radiator 24 includes a left lateral section (second left lateral section) 24c between the front surface section 24a and the rear surface section 24b, and a right lateral section (second right lateral section) 24d between the front surface section 24a and the rear surface section 24b.

The left lateral section 22c of the condenser 22 and the left lateral section 24c of the radiator 24 are provided along, for example, a plane that is defined by front-back and top-bottom directions of the vehicle 10. The right lateral section 22d of the condenser 22 and the right lateral section 24d of the radiator 24 are provided along, for example, a plane that is defined by the front-back and top-bottom directions of the vehicle 10.

In the present embodiment, the front surface section 24a and the rear surface section 24b of the radiator 24 may be configured in such a manner that the top part of the radiator 24 is provided further back than its bottom part, or the bottom part of the radiator 24 is provided further back than its top part. In the present embodiment, it is assumed, for convenience of explanation, that the front surface section 24a and the rear surface section 24b of the radiator 24 are parallel to a plane S that defines the top, bottom, left, and right of the vehicle 10.

Also, in the present embodiment, the rear surface section 22b of the condenser 22 and the front surface section 24a of the radiator 24 are formed in such a manner that a space between their bottom parts is greater than a space between their top parts.

A distance between the intake port 10a and the condenser 22 is suitably set. A distance between the condenser 22 and the radiator 24 is suitably set. The front surface section 24a of the radiator 24 and the rear surface section 22b of the condenser 22 may be provided at any distance by which it can be perceived that the radiator 24 is placed in contact with the rear surface side of the condenser 22. Also, the front surface section 24a of the radiator 24 and the rear surface section 22b of the condenser 22 are provided at a distance that makes it more difficult for the air F that has passed through the intake port 10a to enter a gap between an upper end of the rear surface section 22b of the condenser 22 and an upper end of the front surface section 24a of the radiator 24, as shown in FIG. 1, than a gap between a lower end of the rear surface section 22b of the condenser 22 and a lower end of the front surface section 24a of the radiator 24. Thus, in the present embodiment, the rear surface section 22b of the condenser 22 and the front surface section 24a of the radiator 24 are formed in such a manner that the distance between their bottom parts is greater than the distance between their top parts.

The fan 26 is provided at the back of the radiator 24 on the side of the rear surface section 24b, and is used to cool the condenser 22 and the radiator 24. It is preferable that the fan 26 be provided in the rear surface section 24b of the radiator 24. If the fan 26 is operated, the fan 26 brings, for example, a region R on the side of the rear surface section 24b of the radiator 24, to a more negative pressure than the back of the fan 26. Thus, the fan 26 allows the air F taken in from the intake port 10a to be blown to the condenser 22 and the radiator 24, and flows the air F that has passed through the condenser 22 and the radiator 24 to further back.

The air F from the intake port 10a is directly blown to the front surface section 22a of the condenser 22. A part of the air F that has passed through the condenser 22 is heated by the condenser 22 through heat exchange, passes through the rear surface section 22b of the condenser 22, and is blown to the front surface section 24a of the radiator 24.

The space between a bottommost part of the condenser 22 and a bottommost part of the radiator 24 is wider than a space between a topmost part of the condenser 22 and a topmost part of the radiator 24. If the region R is brought to a negative pressure by the fan 26, the air F from the intake port 10a tries to enter the gap between the rear surface section 22b of the condenser 22 and the front surface section 24a of the radiator 24 from above the condenser 22. Even with the negative pressure of the region R, due to the relatively small gap (space) between the topmost part of the condenser 22 and the topmost part of the radiator 24, it is difficult for the air F to directly enter the gap between the rear surface section 22b of the condenser 22 and the front surface section 24a of the radiator 24 through the space between the topmost part of the condenser 22 and the topmost part of the radiator 24 from the intake port 10a.

Also, if the region R is brought to a negative pressure by the fan 26, the air F from the intake port 10a tries to enter the gap between the rear surface section 22b of the condenser 22 and the front surface section 24a of the radiator 24 from below the condenser 22. Due to the relatively large gap (space) between the bottommost part of the condenser 22 and the bottommost part of the radiator 24, and with the negative pressure of the region R, it is easy for the air F to directly enter the gap between the rear surface section 22b of the condenser 22 and the front surface section 24a of the radiator 24 through the space between the bottommost part of the condenser 22 and the bottommost part of the radiator 24 from the intake port 10a. Thus, the air F from the intake port 10a is blown to the front surface section 24a of the radiator 24 from below the condenser 22. Such air F, which has not been heated by the condenser 22, easily contributes to cooling of the radiator 24.

Also, if the region R is brought to a negative pressure by the fan 26, the air F from the intake port 10a tries to enter the gap between the rear surface section 22b of the condenser 22 and the front surface section 24a of the radiator 24 from the left and right of the condenser 22. Due to the gap (space) increasing from top to bottom at each of the left and right sides of the condenser 22 and the radiator 24, with the negative pressure of the region R, it is easier for the air F to directly enter the gap between the rear surface section 22b of the condenser 22 and the front surface section 24a of the radiator 24 at the bottom than at the top through the space at each of the left and right sides of the condenser 22 and the radiator 24 from the intake port 10a. The air F from the intake port 10a is blown to the front surface section 24a of the radiator 24 from below, rather than from above, of each of the left and right sides of the rear surface section 22b of the condenser 22. Such air F, which has not been heated by the condenser 22, easily contributes to cooling of the radiator 24.

Note that, in FIG. 1, the reference numeral S1 denotes an area of the front surface section 22a of the condenser 22 as denoted by the solid line projected onto the plane S, and the reference numeral S2 denotes an area of the front surface section 22a of the condenser 22 as denoted by the dashed line projected onto the plane S. Also, it is assumed that the central axis C at the topmost part of the condenser 22 and the front surface section 24a at the topmost part of the radiator 24 are at a certain distance in a front-back direction. It is assumed, for example, that the condenser 22 shown in FIG. 1 is inclined relative to the central axis C, which extends in a right-left direction. At this time, it is assumed that a position of the condenser 22 denoted by the solid line and a position of the condenser 22 denoted by the dashed line are deviated by the angle θ around the central axis C. The area S2 is smaller than the area S1. Accordingly, as viewed from the intake port 10a, the condenser 22 at the position denoted by the dashed line hides the front surface section 24a of the radiator 24 by a smaller amount than at the position denoted by the solid line. Thus, with the condenser 22 at the position denoted by the dashed line, the air F from the intake port 10a does not pass through the condenser 22, and is directly blown to the front surface section 24a of the radiator 24 in a larger amount than at the position denoted by the solid line.

In the case where the central axis C of the topmost part of the condenser 22 and the front surface section 24a of the topmost part of the radiator 24 are at a certain distance in the front-back direction, it is possible to improve the cooling property of the radiator 24 as the gap between the bottommost part of the condenser 22 and the bottommost part of the radiator 24 is widened. On the other hand, the area of the condenser 22 that faces the intake port 10a is reduced as the gap between the bottommost part of the condenser 22 and the bottommost part of the radiator 24 is widened. Thus, the area of the front surface section 22a of the condenser 22 over which the air F is blown may be reduced depending on the angle θ.

The cooling property required for the radiator 24 may suitably change according to the relationship with, for example, the amount of heat scheduled to be generated by the heat source 14. If, for example, the radiator 24 placed in contact with the condenser 22 in approximately parallel thereto provides a proper cooling property, the angle θ of the rear surface section 22b of the condenser 22 relative to the plane S, namely, the angle θ of the rear surface section 22b of the condenser 22 relative to the front surface section 24a of the radiator 24 is relatively small, for example, close to 0°. If the cooling property of the radiator 24 needs an improvement, the angle θ of the rear surface section 22b of the condenser 22 relative to the plane S, namely, the angle θ of the rear surface section 22b of the condenser 22 relative to the front surface section 24a of the radiator 24 becomes relatively large.

That is, the maximum angle θ of the condenser 22 relative to the plane S, namely, the angle θ of the rear surface section 22b of the condenser 22 relative to the front surface section 24a of the radiator 24 is preferably equal to or less than 45°, more preferably equal to or less than 30°. In this case, the air F that has passed through the intake port 10a can be blown to the front surface section 22a of the condenser 22. Also, the radiator 24 at the rear surface side of the condenser 22 can be cooled with the air F that has circulated from the bottom side and the left and right sides of the condenser 22 while cooling the condenser 22 with the air F taken in from the intake port 10a.

The vehicle 10, which is, for example, a battery electric vehicle (BEV), a hybrid electric vehicle (HEV), a plug-in hybrid electric vehicle (PHEV), and a fuel-cell electric vehicle (FCEV), includes a package including a battery as the heat source 14. Such a package is suitably selected according to, for example, the vehicle type. For example, the number of batteries loaded on the vehicle 10 may change from package to package, allowing the allowable heat generation amount of the vehicle 10 to change. In this manner, the allowable heat generation amount of the battery, which acts as the heat source 14, may vary depending on, for example, the type of the vehicle 10.

Also, the allowable heat generation amount of the vehicle 10 including an engine may vary depending on the vehicle type, such as the type of the engine, which acts as the heat source 14, and the exhaust amount of the engine. The vehicle 10 further includes a motor and one or more electronic control units (ECUs) as the heat source 14. The allowable heat generation amount of the motor and ECUs may vary depending on the type. Also, the allowable heat generation amount of the vehicle 10 may vary depending on the usage environment.

In this manner, the vehicle 10 may be configured in such a manner, for example, that the specifications of the heat source 14 through which the coolant circulates may vary. In such a case, suitable distribution ratios of the amount and temperature of air (cooling air) F between the front surface section 22a of the condenser 22 and the front surface section 24a of the radiator 24 may vary according to the specifications of the heat source 14.

Standardization of components has been advanced for varying types of vehicles 10, as well as for the same type of vehicle 10. Even in the case where the allowable heat generation amount of the heat source 14 varies among the vehicles 10, if a condenser 22 and a radiator 24 with the same specifications are used for the vehicles 10, the necessity of adjusting the condenser 22 and the cooling property of the radiator 24 provided at the rear surface side of the condenser 22 arises.

In the case of using the cooling apparatus 12 according to the present embodiment, an inclination angle of the condenser 22 can be adjusted relative to the radiator 24. In such a case, the condenser 22 at a frontmost surface of the cooling apparatus 12 can be cooled by the air F taken in from the intake port 10a. Also, by adjusting the inclination angle of the condenser 22 relative to the radiator 24, the cooling apparatus 12 is capable of adjusting the degree by which the air F that is not easily affected by the heat of the condenser 22 is supplied to the front surface section 24a of the radiator 24. Thus, the cooling apparatus 12 according to the present embodiment is capable of adjusting the cooling property of the radiator 24 according to, for example, the allowable heat generation amount of the heat source 14. Accordingly, with the vehicle 10 according to the present embodiment, it is possible to set the property of cooling the radiator 24 to a desired state while maintaining the property of cooling the condenser 22. Also, with the cooling apparatus 12 in which the radiator 24 is provided at the back of the condenser 22, it is possible to suppress an enlargement of the space for disposing the condenser 22 and the radiator 24.

Therefore, according to the present embodiment, it is possible to provide a cooling apparatus 12 for a vehicle 10 in which a radiator 24 is provided at the back of a condenser 22, configured to be able to suppress a decrease in the property of cooling the radiator 24 while maintaining the property of cooling the condenser 22, and the vehicle 10 including the cooling apparatus 12.

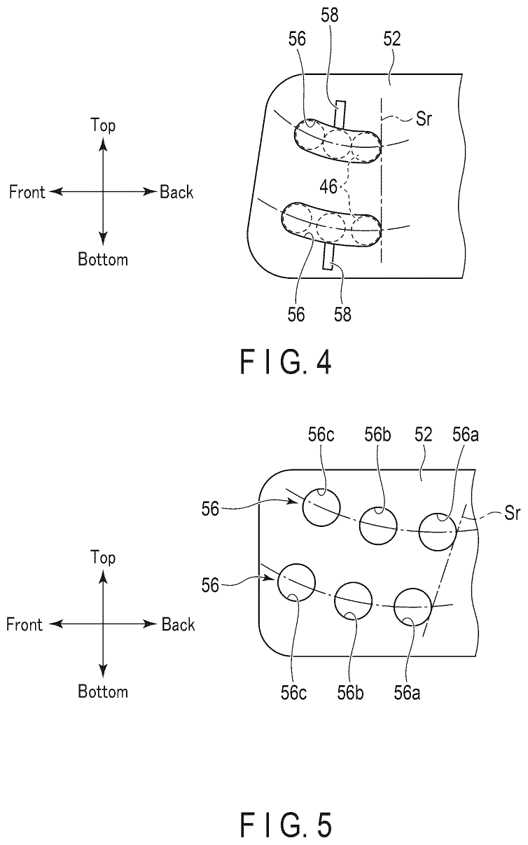

FIG. 2 shows a left bracket 32 for determining a positional relationship between the condenser 22 and the radiator 24 at the left side of the vehicle 10. FIG. 3 shows a right bracket 34 for determining a positional relationship between the condenser 22 and the radiator 24 at the right side of the vehicle 10. FIG. 4 is a schematic diagram showing a plate 52 of the left bracket 32 in FIG. 2, provided along a plane that is defined by top-bottom and front-back directions.

As shown in FIGS. 2 and 3, the cooling apparatus 12 includes a pair of brackets 32 and 34 for determining a positional relationship between the condenser 22 and the radiator 24. The pair of brackets 32 and 34 is adapted to fasten the condenser 22 to the radiator 24 from both sides of the vehicle 10 in its width direction. In the present embodiment, the pair of brackets 32 and 34 is adapted to steplessly adjust an inclination angle of the rear surface section 22b of the condenser 22 relative to the front surface section 24a of the radiator 24, and allows fastening therebetween.

As shown in FIG. 2, the left bracket 32 includes a first-1 bracket body (first bracket body) 42 fastened to a left end part of the condenser 22, and a first-2 bracket body (second bracket body) 44 fastened to a left end part of the radiator 24. The positional relationship between the first-1 bracket body 42 and the first-2 bracket body 44 is fixed by, for example, a plurality of bolts 46. The left end part of the condenser 22 refers to one or more of a left end of the front surface section 22a, a left end of the rear surface section 22b, and the left lateral section 22c of the condenser 22. The left end part of the radiator 24 refers to one or more of a left end of the front surface section 24a, a left end of the rear surface section 24b, and the left lateral section 24c of the radiator 24. In the present embodiment, the first-1 bracket body 42 is fastened to, for example, the left end of the front surface section 22a and the left lateral section 22c of the condenser 22.

The first-1 bracket body 42 is formed of two bodies each bent in an approximately L-shape and distanced from each other in the top-bottom direction. The first-1 bracket body 42 may be formed of a single body or three or more bodies.

In the first-1 bracket body 42, a plurality of sets of bolt fastener holes 42a are formed. Each of the bolt fastener holes 42a is formed in a size that allows each bolt 46 to be fastened thereto. It is preferable that the bolt fastener holes 42a of each pair be provided at an equal interval along a direction (top-bottom direction) in which the left lateral section 22c of the condenser 22 extends. The bolt fastener holes 42a of each pair are formed at the same interval as the interval between bolt insertion holes 56, to be described below, adjacent thereto in the top-bottom direction.

Note that FIG. 2 shows an example in which the first-1 bracket body 42 is fastened to the front surface section 22a of the condenser 22 with bolts 48 through bolt fastener holes 42b; however, the first-1 bracket body 42 is not required to be fastened to the front surface section 22a of the condenser 22. In FIG. 2, ten bolt fastener holes 42b are shown. In the case where the bracket bodies 42 are fastened to the front surface section 22a of the condenser 22 with the bolts 48, it suffices that the fastening is performed through two or more bolt fastener holes 42b of each bracket body 42.

For example, the first-2 bracket body 44 is fastened to the left end of the front surface section 24a of the radiator 24. The first-2 bracket body 44 is formed of a single body, but may be formed of two or more bodies.

The first-2 bracket body 44 includes plates 52 and 54 distanced from each other in the top-bottom direction and provided along a plane that is defined by the top-bottom and front-back directions. The plates 52 and 54 protrude further toward the front than the second front surface section 24a. The plates 52 and 54, namely, the first-2 bracket body 44, include bolt insertion holes 56 as adjusters for allowing the positions of the bolts 46 to be adjusted. A pair of bolt insertion holes 56 is formed in each of the plates 52 and 54. It is assumed that the plate 52 is located above the plate 54.

FIG. 4 is a diagram showing the plate 52 of the first-2 bracket body 44 as viewed from the left. In the present embodiment, each of the bolt insertion holes 56 is formed as an arc-shaped slit. It is preferable that a central axis of an arc of the bolt insertion hole 56, which is an arc-shaped slit, match the central axis C of pivoting of the condenser 22. That is, the central axis of the arc of the bolt insertion hole 56, which is an arc-shaped slit, may be provided at an upper end (upper edge) of the rear surface section 22b of the condenser 22, or may be provided further above the upper end of the rear surface section 22b of the condenser 22. It is assumed herein that the central axis of the arc of the bolt insertion hole 56, which is an arc-shaped slit, is provided at an upper end (upper edge) of the rear surface section 22b of the condenser 22.

In FIG. 4, an upper edge of each bolt insertion hole 56 is formed in an arc shape at an equal distance from the central axis of the arc of the bolt insertion hole 56. Also, a lower edge of each bolt insertion hole 56 is formed in an arc shape at an equal distance from the central axis of the arc of the bolt insertion hole 56.

In the plate 52, a plurality of (two in the illustrated case) bolt insertion holes 56, which are arc-shaped slits, are formed one above the other. Of the two bolt insertion holes 56 of the plate 52, the length of the arc of the lower bolt insertion hole 56 (length of the opening in the front-back direction) is greater than the length of the arc of the upper bolt insertion hole 56 (length of the opening in the front-back direction), since the central axis C of the arc of the bolt insertion hole 56 is located above the plate 52. Note that a virtual end face Sr connecting two positions at backmost ends of the two bolt insertion holes 56 is parallel to the plane S.

The same applies to the two bolt insertion holes 56 of the plate 54 shown in FIG. 2. Note that the plate 54, which is located below the plate 52, is further distanced from the central axis C of the arc of the bolt insertion hole 56. Thus, the length of the arc of the bolt insertion hole 56 (length of the opening in the front-back direction) of the plate 54 is greater than the length of the arc of the bolt insertion hole 56 (length of the opening in the front-back direction) of the plate 52.

In the example of the bolt insertion holes 56 of the plate 52 shown in FIGS. 2 and 4, the bolt 46 may be provided at any position between a front end and a back end of each bolt insertion hole 56. In this case, the bolts 46 are fastened into the bolt fastener holes 42a of the first-1 bracket body 42 through the bolt insertion holes 56 of the first-2 bracket body 44, thus allowing the first-1 bracket body 42 to be positioned at an angle θ of a predetermined range relative to the first-2 bracket body 44.

As shown in FIG. 3, the right bracket 34 includes a second-1 bracket body (first bracket body) 62 fastened to a right end part of the condenser 22, and a second-2 bracket body (second bracket body) 64 fastened to a right end part of the radiator 24. The positional relationship between the second-1 bracket body 62 and the second-2 bracket body 64 is fixed by, for example, a plurality of bolts 66. The right end part of the condenser 22 refers to one or more of a right end of the front surface section 22a, a right end of the rear surface section 22b, and the right lateral section 22d of the condenser 22. The right end part of the radiator 24 refers to one or more of the right end of the front surface section 24a, the right end of the rear surface section 24b, and the right lateral section 24d of the radiator 24. In the present embodiment, the second-1 bracket body 62 is fastened to, for example, the right end of the front surface section 22a and the right lateral section 22d of the condenser 22.

In the present embodiment, the second-1 bracket body 62 includes a first member 63a and a second member 63b.

The first member 63a is bent in an approximately L-shape. The first member 63a may be formed of a single body, or may be formed of two bodies as in the first-1 bracket body 42. Alternatively, the first member 63a may be formed of three or more bodies.

In the first member 63a, a plurality of sets of bolt fastener holes 62a are formed. Each of the bolt fastener holes 62a is formed in a size that allows each bolt 66 to be fastened thereto. It is preferable that the bolt fastener holes 62a of each pair be provided at an equal interval along a direction (top-bottom direction) in which the right lateral section 22d of the condenser 22 extends.

An example is shown in which the second member 63b is fastened to the front surface side of the first member 63a on the side of the front surface section 22a of the condenser 22 with the bolts 68 through the bolt fastener holes 62b; however, the second member 63b is not required to be fastened to the front surface section 22a of the condenser 22. Also, the second member 63b is fastened, with a nut 69b, to a threaded shaft 69a extending to the front from the first member 63a.

The second-2 bracket body 64 is, for example, fastened to the right end of the front surface section 24a of the radiator 24. The second-2 bracket body 64 is formed of a single body, but may be formed of two or more bodies.

The second-2 bracket body 64 includes a plate 72 provided along a plane that is defined by the top-bottom and front-back directions. The plate 72 protrudes further toward the front than the second front surface section 24a. The second-2 bracket body 64 includes bolt insertion holes 74 as adjusters for allowing the positions of the bolts 66 to be adjusted. Two pairs of bolt insertion holes 74 that are distanced from each other in the top-bottom direction are formed in the plate 72. It is preferable that the bolt insertion holes 74 be formed bilaterally symmetric in the same shape and size as those of the bolt insertion holes 56 of the first-2 bracket body 44 shown in FIGS. 2 and 4.

Accordingly, in the present embodiment, each of the bolt insertion holes 74 is formed as an arc-shaped slit, similarly to the bolt insertion holes 56. It is thus preferable that a central axis of an arc of the bolt insertion hole 74, which is an arc-shaped slit, match the central axis C of pivoting of the condenser 22. That is, the central axis of the arc of the bolt insertion hole 74, which is an arc-shaped slit, may be provided at an upper end (upper edge) of the rear surface section 22b of the condenser 22, or may be provided further above the upper end of the rear surface section 22b of the condenser 22. It is assumed herein that the central axis of the arc of the bolt insertion hole 74, which is an arc-shaped slit, is provided at an upper end (upper edge) of the rear surface section 22b of the condenser 22.

By adjusting the positions of the bolts 46 to be inserted through the bolt insertion holes 56 of the left bracket 32 and the positions of the bolts 66 to be inserted through the bolt insertion holes 74 of the right bracket 34 at positions between a front end and a back end of each bolt insertion hole 56 and each bolt insertion hole 74, it is possible to steplessly adjust an inclination angle of the rear surface section 22b of the condenser 22 relative to the front surface section 24a of the radiator 24, thus allowing the condenser 22 to be fastened at the adjusted position.

As shown in FIGS. 2 and 4, a marker 58 is formed in the periphery of each bolt insertion hole 56 of the plate 52. The marker 58 shows an example of the position where the bolt 46 is to be provided. The marker 58 is at an intermediate position between a front end and a back end of the bolt insertion hole 56. As shown in FIG. 3, a marker 76 is formed in the periphery of each bolt insertion hole 74. The marker 76 shows an example of the position where the bolt 66 is to be provided.

The markers 58 and 76 are provided so as to be bilaterally symmetric. It suffices that the markers 58 and 76 are visually recognizable. It is thus preferable that the markers 58 and 76 be formed as indicators of distinctive colors in contrast to the colors of the bracket bodies 44 and 64. Alternatively, it is also preferable that the markers 58 and 76 be formed as notches by, for example, punching the bracket bodies 44 and 64.

In the upper bolt insertion holes 56 of the plate 52 in FIG. 4, the positions where three bolts 46 are to be provided are shown by dashed lines. By arranging the bolt 46 at the front-end position of each bolt insertion hole 56, the angle θ of the rear surface section 22b of the condenser 22 relative to the front surface section 24a of the radiator 24 can be set to 30°. Similarly, by arranging the bolt 46 at an intermediate position where the marker 58 is provided between the front end and the back end of each bolt insertion hole 56, the angle θ of the rear surface section 22b of the condenser 22 relative to the front surface section 24a of the radiator 24 can be set to 15°. Similarly, by arranging the bolt 46 at the back-end position of each bolt insertion hole 56, the angle θ of the rear surface section 22b of the condenser 22 relative to the front surface section 24a of the radiator 24 can be set to 0°.

Through use of the brackets 32 and 34 according to the present embodiment, it is possible to suitably make the bottom part of the condenser 22 close to or far from the bottom part of the radiator 24, with the top part of the condenser 22 kept close to the top part of the radiator 24. It is thus possible to fix the positional relationship between the condenser 22 and the radiator 24 either steplessly or in multiple steps using, for example, a single type of brackets 32 and 34 according to, for example, various specifications of the heat source 14. By thus adjusting the positional relationship between the condenser 22 and the radiator 24, it is possible to manufacture vehicles 10 of various types that vary in, for example, the allowable heat generation amount of the heat source 14, using common components (i.e., the condenser 22, the radiator 24, and the pair of brackets 32 and 34).

An example has been described, with reference to FIG. 4, in which the upper edge and the lower edge of each bolt insertion hole 56 are formed in an arc shape at an equal distance from the central axis of the arc of the bolt insertion hole 56. It is also preferable that the upper edge and the lower edge of each bolt insertion hole 56 be formed as divided holes (circular pores) 56a, 56b, and 56c each allowing the diameter of the bolt 46 to fit therein, as shown in FIG. 5, instead of the arc shape at an equal distance from the central axis of the arc of the bolt insertion hole 56. In FIG. 5, a state is shown in which the bolt insertion holes 56 are formed as divided holes 56a, 56b, and 56c; however, holes 56a and 56b and holes 56b and 56c, which are adjacent in the front-back direction, may be formed to be continuous. Of the bolt insertion holes 56, the backmost holes 56a are provided so as to be deviated from each other in the top-bottom direction, as shown in FIG. 5. In an example, a virtual end face Sr connecting two positions at backmost ends of the two bolt insertion holes 56 is inclined to the plane S. The end face Sr is provided in such a manner that its lower part is further to the front and its upper part is further to the back. Thus, the end face Sr may be provided in such a manner that the angle θ>0° is satisfied, namely, the rear surface section 22b of the condenser 22 is always inclined relative to the front surface section 24a of the radiator 24. In the case where, for example, the bolts 46 are inserted through the holes 56a, the angle θ can be set to, for example, 10°. In the case where, for example, the bolts 46 are inserted through the holes 56b, the angle θ can be set to, for example, 20°. In the case where, for example, the bolts 46 are inserted through the holes 56c, the angle θ can be set to, for example, 30°.

In the present embodiment, an example has been described in which the first-2 bracket body 44 includes bolt insertion holes 56 as arc-shaped slits or holes (circular pores) 56a, 56b, and 56c, which are adjusters for allowing the positions of the bolts 46 to be adjusted. It is also preferable, for example, that the first-1 bracket body 42 include bolt insertion holes (adjusters) as arc-shaped slits or holes (circular pores) 56a, 56b, and 56c, and that the first-2 bracket body 44 include a single circular bolt fastener hole. It is also preferable that both the first-1 bracket body 42 and the first-2 bracket body 44 include bolt insertion holes (adjusters) as arc-shaped slits or holes (circular pores) 56a, 56b, and 56c.

### Second Embodiment

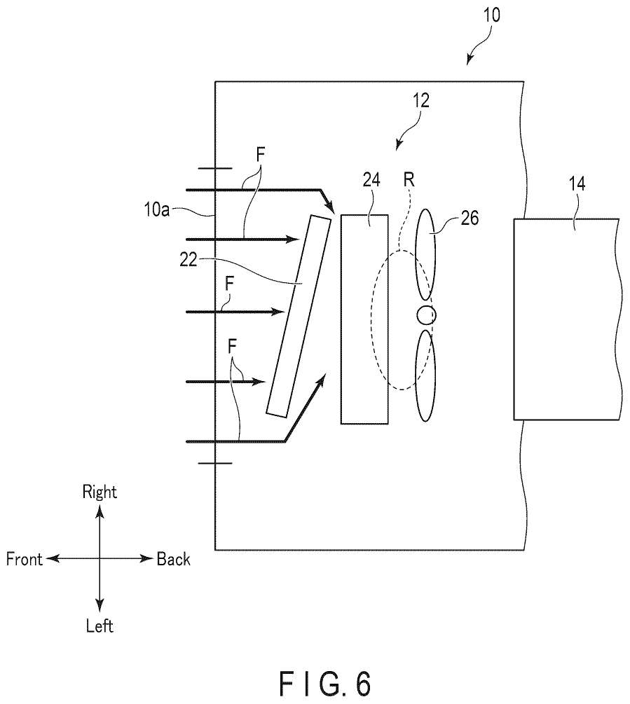

A vehicle 10 including a cooling apparatus 12 according to a second embodiment will be described with reference to FIG. 6. In the present embodiment, which is a variant of the first embodiment, members that are the same as those described or members having the same functions as those described in the first embodiment will be denoted by the same reference numerals, and a detailed description thereof will be omitted.

FIG. 6 is a schematic diagram showing a part of a front section of the vehicle 10 according to the second embodiment.

The front, back, left, and right of the vehicle 10 are assumed as shown in FIG. 6. As shown in FIG. 6, the vehicle 10 includes an intake port 10a for air F configured to be open to a front surface of the vehicle 10.

The space between the rear surface section 22b of the condenser 22 and the front surface section 24a of the radiator 24 is formed so as to be relatively small on the right side and is wider on the left side. That is, in the present embodiment, the rear surface section 22b of the condenser 22 and the front surface section 24a of the radiator 24 are formed in such a manner that a space between their left parts is greater than a space between their right parts.

The condenser 22 is inclined relative to a central axis C, which extends in a top-bottom direction, and is fastened at a desired angle. The central axis C may be provided at a right end (right edge) of the rear surface section 22b of the condenser 22, or may be provided further to the right of the right end of the rear surface section 22b of the condenser 22.

The air F from the intake port 10a is directly blown to the front surface section 22a of the condenser 22. A part of the air F that has passed through the condenser 22 is heated by the condenser 22 through heat exchange, passes through the rear surface section 22b of the condenser 22, and is blown to the front surface section 24a of the radiator 24.

The space between a leftmost part of the condenser 22 and a leftmost part of the radiator 24 is wider than a space between a rightmost part of the condenser 22 and a rightmost part of the radiator 24. At this time, the air F from the intake port 10a tries to enter the space between the rear surface section 22b of the condenser 22 and the front surface section 24a of the radiator 24 from the right of the rear surface section 22b of the condenser 22; however, due to the relatively small space between the rightmost part of the condenser 22 and the rightmost part of the radiator 24, it is difficult for the air F to enter the space between the rear surface section 22b of the condenser 22 and the front surface section 24a of the radiator 24. Also, the air F from the intake port 10a tries to enter the space between the rear surface section 22b of the condenser 22 and the front surface section 24a of the radiator 24 from the left of the rear surface section 22b of the condenser 22. The space between the leftmost part of the condenser 22 and the leftmost part of the radiator 24 is relatively wide, allowing the air F to easily enter the space between the rear surface section 22b of the condenser 22 and the front surface section 24a of the radiator 24. Thus, the air F from the intake port 10a is blown to the front surface section 24a of the radiator 24 from the left of the rear surface section 22b of the condenser 22. Such air F, which has not been heated by the condenser 22, easily contributes to cooling of the radiator 24.

Note that a part of the air F that has circulated above or below the rear surface section 22b of the condenser 22 from the intake port 10a is blown to the front surface section 24a of the radiator 24. Such air F, which has not been heated by the condenser 22, easily contributes to cooling of the radiator 24.

It is also preferable that the space between the rear surface section 22b of the condenser 22 and the front surface section 24a of the radiator 24 be formed so as to be relatively narrower on the left side and is wider on the right side. It thus suffices that the rear surface section 22b of the condenser 22 and the front surface section 24a of the radiator 24 are formed in such a manner that a space between end parts at either the right or left side is greater than a space between end parts at the opposite side.

According to the present embodiment, it is possible to provide a cooling apparatus 12 for a vehicle 10 in which a radiator 24 is provided at the back of a condenser 22, configured to be able to suppress a decrease in the property of cooling the radiator 24 while maintaining the property of cooling the condenser 22, and the vehicle 10 including the cooling apparatus 12.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cooling apparatus for a vehicle, comprising:
a condenser provided at a back of an air intake port that opens to a front surface of the vehicle,
the condenser including a first front surface section and a first rear surface section, the first front surface section receiving air that has passed through the air intake port;
a radiator provided at a back of the condenser,
the radiator including a second front surface section and a second rear surface section, the second front surface section facing the first rear surface section; and
a fan provided on a side of the second rear surface section of the radiator and configured to allow the air from the air intake port to blow to the condenser and the radiator,
wherein:
a space between bottom parts of the first rear surface section of the condenser and the second front surface section of the radiator is greater than a space between top parts of the first rear surface section of the condenser and the second front surface section of the radiator, or
a space between end parts of the first rear surface section of the condenser and the second front surface section of the radiator at one of a right side and a left side is greater than a space between end parts of the first rear surface section of the condenser and the second front surface section at a remaining side of the right side and the left side.

2. The cooling apparatus according to claim 1, further comprising:
a pair of brackets configured to define an inclination angle of the first rear surface section of the condenser in multiple steps or steplessly, relative to the second front surface section of the radiator.

3. The cooling apparatus according to claim 2, wherein
when the space between the bottom parts is greater than the space between the top parts, the pair of brackets is configured to fasten the condenser to the radiator from both sides of the vehicle in a width direction.

4. The cooling apparatus according to claim 2, wherein
each of the pair of brackets includes:
a first bracket body provided at the condenser; and
a second bracket body provided at the radiator.

5. The cooling apparatus according to claim 4, wherein
the second bracket body includes an adjuster configured to adjust a bolt position where the second bracket body is fastened to the first bracket body.

6. A vehicle comprising:
the air intake port which opens to the front surface of the vehicle; and
the cooling apparatus according to claim 1.
